(19) United States
(12) Patent Application Publication
(10) Pub. No.: US 2006/0293179 A1
(43) Pub. Date: Dec. 28, 2006

(54) Composition and method for reducing chemical oxygen demand in water

(76) Inventor: Roy W. Martin, Downers Grove, IL (US)

Correspondence Address: DLA Piper Rudnick Gray Cary LLP, Suite 800, 153 Townsend Street, San Francisco, CA, 94107-1957, US

(21) Appl. No.: 11/494,228

(22) Filed: Jul. 27, 2006

Related U.S. Application Data
(63) Continuation-in-part of application No. 11/158,676, filed on Jun. 22, 2005.

(51) Int. Cl. B01J 23/00; C02F 9/00

(52) U.S. Cl. 502/321; 210/631

(57) ABSTRACT

A method and composition for reducing chemical oxygen demand is presented. The composition includes a sulfate free radical precursor and a transition metal catalyst in contact with the sulfate free radical precursor. When the composition comes into contact with water, the transition metal catalyst reacts with the sulfate free radical precursor and produces sulfate free radicals in the water. The composition produces sulfate free radicals which reduce chemical oxygen demand in the water of aquatic facilities. The composition is provided in the form of a powder, granules (coated or uncoated), or an agglomerate.

### CROSS-REFERENCE TO RELATED APPLICATIONS

This application is a Continuation-in-part of U.S. patent application Ser. No. 11/158,676, filed Jun. 22, 2005. The priority application is expressly incorporated by reference herein in its entirety.

### FIELD OF INVENTION

This invention relates generally to compositions and methods for reducing chemical oxygen demand in water. The compositions and methods find utility in cleaning an aquatic facility and more particularly in cleaning an aquatic facility that contains organic contaiminants.

### BACKGROUND

Aquatic facilities such as swimming pools and spas have become increasingly popular in private homes, hotels, fitness centers, and resorts. To ensure that the aquatic facilities can be enjoyed safely, the water must be treated to reduce or eliminate chemical oxygen demands (COD) and/or total organic carbon (TOC). When the COD and/or TOC increases in the water, the oxidation reduction potential of the water decreases and oxidizers are added to maintain a healthy level of oxidation reduction potential. The COD is an indicator of the overall level of organic contamination. This contamination is measured by quantifying the equivalent amount of oxygen required to oxidize organic mater in a sample. Organic matter in an aquatic facility may come from any living organism, including leaves, bugs, urine, perspiration, cosmetics, essentially anything containing carbon. Oxidation is a chemical process used to remove undesirable organic and inorganic compounds from water. Common oxidizers that are used in aquatic facilities include chlorine or bromine. However, when chlorine or bromine is present in the water above a certain level, and in the presence of COD and/or TOC, trihalomethanes (THM) and chloramines form in the water undesirably. Trihalomethanes (THMs) are believed to be toxic and are currently regulated by the environmental protection agency (EPA). Chlorine reacts with bodily proteins to form chloramines, the most volatile and prevalent THM in the air above swimming pools is nitrogen trichloride (NCl₃).

Common ingredients for treating water systems include various persulfate salts and persulfate donors such as potassium monopersulfate (PMPS), which is typically available in the form of a triple salt, (KHSO₅)ₓ.(KHSO₄)_{y}.(K₂SO₄)_{z} (herein referred to as “PMPS triple salt”). However, persulfate salts, such as potassium persulfate (K₂S₂O₈), are difficult to use because they cause severe irritation to aquatic facility users (e.g., swimmers, bathers) at concentrations above about 2 ppm. The strong oxidation potential of PMPS triple salt makes it effective for decreasing the concentration of COD. Typically, these chemicals are applied to the aquatic facility through a “shock treatment” whereby the facility is evacuated and the product is broadcast across the water surface. The facility users may not be allowed to come in contact with the treated water for a period of time after the treatment due to concerns for irritation.

PMPS usually contains potassium persulfate (K₂S₂O₈) as a result of being prepared using oleum. Persulfates have a long half life in aquatic facilities and are undesirable. As a result of the concerns for irritation resulting from accumulation of persulfate, PMPS can be used only at limited dosages, which typically do not exceed two pounds per 10,000 gallons of water per week.

While PMPS maintains the water quality in aquatic facilities reasonably well, they are inconvenient to use because of the need to evacuate the facility during use and the fact that PMPS it can only be used in limited doses regardless of how heavily the facility is used. Thus, a method for treating water systems without these inconvenient limitations is desirable.

### SUMMARY OF THE INVENTION

In one aspect, the invention provides compositions and methods for reducing chemical oxygen demand in water, for example for use in an aquatic facility.

In one embodiment, the invention provides a composition for reducing chemical oxygen demand in water, which includes: a sulfate free radical precursor and a transition metal catalyst in contact with said sulfate free radical precursor, wherein the transition metal catalyst makes up between about 0.0001 wt. % and about 10 wt. % of the composition;

In one aspect, the transition metal catalyst coats the sulfate free radical precursor, e.g., one or more of potassium monopersulfate, sodium persulfate, and potassium persulfate.

In another aspect, the composition is dissolved in water to form a solution that is delivered to the water.

The composition may be a powder, granular or be provided as an agglomerate. The composition may further include an agent that restricts a dissolution rate of the agglomerate in water, such as a substantially water-insoluble wax; a mineral salt of a carboxylic acid having at least 16 carbons or a gel forming material that forms a gelatinous structure upon contacting water.

In yet another aspect, the transition metal catalyst comprises cobalt or manganese. The cobalt or manganese, respectively, may be provided in the form of an inorganic salt, an organic based ligand bearing compound or an oxide.

The composition may include a chelating agent in contact with the transition metal catalyst.

In another embodiment, the invention provides a composition for reducing chemical oxygen demand in water, which includes: a free halogen donor; a sulfate free radical precursor; and a transition metal catalyst, wherein the free halogen donor, the sulfate free radical precursor, and the transition metal catalyst are agglomerated and may be soluble in water.

The sulfate free radical precursor may be one or more of potassium monopersulfate, sodium persulfate and potassium persulfate and may be present in an amount between about 0.00001 wt. % and 10 wt. % of the composition.

In one aspect of this embodiment, the transition metal catalyst comprises cobalt or manganese. The cobalt or manganese, respectively, may be provided in the form of an inorganic salt, an organic based ligand bearing compound or an oxide.

The composition may include a chelating agent in contact with the transition metal catalyst.

In another aspect of this embodiment, the composition the free halogen donor may comprise comprises about 50-99 wt. % of the composition and is one or more of calcium hypochlorite, trichloroisocyanuric acid, dichloroisocyanuric acid, dibromodimethyl hydantoin, bromochlorodimethyl hydantoin and lithium hypochlorite.

In yet another aspect of this embodiment, the sulfate free radical precursor is separated from the free halogen donor.

In a further aspect of this embodiment the composition comprises a chlorite donor.

In some cases, the sulfate free radical precursor and the transition metal catalyst comprise about 1-50 wt. % of the composition.

In yet a further aspect of this embodiment the composition comprises an agent that restricts a dissolution rate of the composition such as a substantially water-insoluble wax; a mineral salt of a carboxylic acid having at least 16 carbons or a gel forming material that forms a gelatinous structure upon contacting water.

In yet another embodiment, the invention provides a composition for removing chemical oxygen demand from an aquatic facility, the composition comprising a transition metal catalyst in an amount that makes up between about 0.01 wt. % and about 10 wt. % of the composition; and a sulfate free radical precursor in an amount that makes up between about 90-99.99 wt. % of the composition.

The invention further provides methods of removing chemical oxygen demand from water. In one embodiment, the method comprises maintaining a transition metal catalyst concentration level of between about 1 ppb and about 1 ppm measured as elemental metal in the water and adding a sulfate free radical precursor to the water.

In one aspect of this embodiment, the transition metal catalyst comprises cobalt or manganese. The cobalt or manganese, respectively, may be provided in the form of an inorganic salt, an organic based ligand bearing compound or an oxide.

The composition may include a chelating agent in contact with the transition metal catalyst.

The sulfate free radical precursor may be one or more of potassium monopersulfate, sodium persulfate and potassium persulfate and may be added in the form of a solution, e.g., by admixing said sulfate free radical precursor powder with water in a container or by passing the water over an agglomerate of said sulfate free radical precursor.

In one aspect of this method, the sulfate free radical precursor agglomerated with an agent to form an agglomerate, wherein the agent restricts the dissolution rate of the agglomerate in the water. Exemplary agent include a substantially water-insoluble wax, a mineral salt of a carboxylic acid having at least 16 carbons and a gel forming material that forms a gelatinous structure upon contacting water.

In another embodiment, the method of removing chemical oxygen demand from water containing organic contaminants, comprises preparing a sulfate free radical precursor solution; adding a catalyst to the sulfate free radical precursor solution; and feeding the sulfate free radical precursor solution to the water.

In one aspect of this embodiment, the catalyst comprises cobalt or manganese. The cobalt or manganese, respectively, may be provided in the form of an inorganic salt, an organic based ligand bearing compound or an oxide.

The composition may include a chelating agent in contact with the transition metal catalyst.

The sulfate free radical precursor may be one or more of potassium monopersulfate, sodium persulfate and potassium persulfate and may be added in the form of a solution, e.g., by admixing said sulfate free radical precursor powder with water in a container or by passing the water over an agglomerate of said sulfate free radical precursor.

In a further embodiment, the method of removing chemical oxygen demand from water containing organic contaminants, comprises adding a sulfate free radical precursor to the aqueous system; and adding a catalyst comprising a cobalt donor to the water to achieve from about 1 ppb to 1 ppm of catalyst measured as elemental cobalt.

The sulfate free radical precursor and catalyst may be added separately or together.

The sulfate free radical precursor and catalyst may be admixed prior to addition to an aqueous system, e.g., an aquatic system.

In one aspect of this embodiment, a free halogen donor is also added to the aqueous system.

### DETAILED DESCRIPTION OF THE INVENTION

The various compositions and methods of the invention are described below. Although particular compositions and methods are exemplified herein, it is understood that any of a number of alternative compositions and methods are applicable and suitable for use in practicing the invention.

The practice of the present invention will employ, unless otherwise indicated, conventional techniques of water chemistry, which are known to those of skill in the art. Such techniques are explained fully in the literature.

### DEFINITIONS

As used herein, a “persulfate donor” is any compound or composition that includes at least 0.5 wt. % S₂O₈²⁻ donor, such as sodium persulfate, potassium persulfate, and PMPS (potassium monopersulfate) produced from oleum.

As used herein, a “water system” is any facility including a body of water. A “contaminant” refers to a substance that reacts with and consumes a sanitizer/oxidizer, and often comes in the form of organic compounds generated by users. A “user” of a water system is a person or a mammal using the water system in manner that it is intended to be used.

As used herein, the term “chemical oxygen demand” means any substance regardless of it's source that imposes a demand on the oxidizer(s) disclosed in this invention. This “demand” results in the use or consumption of the oxidizer(s) by a reaction between the oxidizer(s) and demand.

“Chemical oxygen demand” determines the oxygen (O.sub.2) consumption as a result of both biodegradable and non-biodegradable organic matters in the water.

As used herein, “organic contaminants” typically take the form of lipids, fats, oils, grease, proteins, urea, cyanuric acid, hydantoin, and a wide range of chemicals and oxidation byproducts including combined chlorine, trihalomethanes, monochloramines, dichloramines, trichloramines, and the like. Organic contaminants in short are carbon based compounds that impose a demand on the oxidizer system disclosed in this invention.

As used herein, a “film” is any layer of a material.

As used herein, the term “a free halogen donor” is any halogen donor whereby upon dissolution in water results in the formation of free halogen species. In the case of chlorine donors, hypochlorous acid (HOCl), hypochlorite ions (OCl—) &/or gaseous Cl₂ are formed. In the case of bromine donors: Hypobromous acid (HOBr), hypobromite ions (OBr—), &/or gaseous Br₂ are formed.

Exemplary free halogen donors include, but are not limited to calcium hypochlorite, trichloroisocyanuric acid, dichloroisocyanuric acid, dibromodimethyl hydantoin, bromochlorodimethyl hydantoin, and lithium hypochlorite.

As used herein, a “potassium monopersulfate composition” is a composition that contains KHSO.sub.5, including KHSO.sub.5 in its triple salt form (KHSO.sub.5).sub.x.(KHSO.sub.4).sub.y.(K.sub.2 SO.sub.4).sub.2. A “peroxide solution” and a “sulfuric acid solution” refer to solutions of H.sub.2 O.sub.2 and water, and H.sub.2 SO.sub.4 and water, respectively. “Oleum” refers to free SO.sub.3 dissolved in H.sub.2 SO.sub.4. A “Caro's acid solution” refers to Caro's acid (H.sub.2 SO.sub.5) mixed with one or more of H.sub.2 O.sub.2, H.sub.2 0, and H.sub.2 SO.sub.4.

The terms “stabilizing” and “stabilized,” when used in reference to the Caro's acid solution, indicate the suppression of the equilibrium reaction, or suppression of Reaction 1b (see below) that converts the H.sub.2 SO.sub.5 back to the reactants. A “stable” potassium monopersulfate composition, on the other hand, has an active oxygen loss of <1% per month. “Non-hygroscopic” means having a K:S ratio greater than 1.

As used herein, the term “sulfate free radical precursor” is used with reference to a chemical substance from which the sulfate free radical is produced when exposed to the catalyst in an aqueous solution.

Exemplary sulfate free radical precursors include, but are not limited to potassium monopersulfate, sodium persulfate, and potassium persulfate transition metal catalyst coated agglomerate.

As used herein, a “transition metal catalyst” means is a molecule comprised of one or more transition metals as defined by the periodic table, where upon dissolution in an aqueous solution containing a sulfate free radical precursor, catalytically induces formation of the sulfate free radical.

Exemplary transition metal catalysts include, but are not limited to, compositions comprising cobalt or manganese, e.g., an inorganic salt, an organic based ligand bearing compound and an oxide.

As used herein, the term “agent that restricts a dissolution rate of the composition/agglomerate in water” is used with reference to a chemical or chemicals that restricts the dissolution and/or dissipation of the composition into the water. By virtue of restricting the dissipation of the composition, the time required to dissolve or disperse the composition is extended.

As used herein, the term “substantially water-insoluble wax” is used with reference to a hydrocarbon based waxy substance that has very limited solubility in water, and therefore substantially increases the time required to dissolve or disperse the composition.

As used herein, the term “aquatic facility” means is used with reference to recreational water systems including: swimming pools, spas, fountains, theme parks, water parks, water theaters, and the like. This includes all private (residential) and professional (commercial and municipal) owned and operated facilities.

### METHODS AND COMPOSITIONS OF THE INVENTION

The invention discloses a composition and a method for removing the COD from water, and finds particular utility in aquatic facilities while the facility is being used by swimmers, bathers, etc. By employing the methods and compositions of the invention, the invention, the COD is decomposed as it is added to the water. Thus, the formation of toxic metabolites of standard oxidants such as chlorine and bromine (THMs and chloramines) is significantly reduced and the quality of air and water around the aquatic facility is enhanced.

The invention allows the application of improved oxidants (e.g., potassium persulfate), while the water is being used by swimmers/bathers. Irritation to the bathers is avoided by using a catalyst that rapidly reacts with the persulfate to form sulfate free radicals. This rapid catalyzed reaction eliminates the concern of persulfate accumulation, and effectively decomposes the organic contaminants shortly after being added to the water, thereby preventing their accumulation.

The invention entails applying a catalyst to the water to maintain an “effective catalyst concentration,” which is between about 1 ppb and about 1 ppm, more preferably between about 5 ppb and about 500 ppb. Then, a persulfate donor is added to the water, inducing the in-situ generation of sulfate free radicals through a catalyzed reaction. Compounds that generate sulfate free radicals are sulfate free radical precursors since they are transformed into the radical during their application. Sulfate free radicals have a reported potential of about 2.6 v.

When a low level of persulfate is applied to water in the presence of the catalyst, sulfate free radicals are formed that effectively decompose the organic compounds, as follows:
SO₂O₈²⁻+Catalyst→Catalyst+SO₄²⁻+.SO₄⁻.SO₄²⁻+H₂O→OH⁻.+HSO₄⁻

hen the sulfate free radicals decompose the organic compounds, any sanitizer (e.g., free halogen donor) in the water is freed to effectively eliminate chemical oxygen demands (COD) and/or total organic carbon (TOC) and thereby control bacterial and viral counts.

The persulfate donor may be one or more of potassium monopersulfate, sodium persulfate, potassium persulfate, or any combination thereof.

The catalyst may be a transition metal donor, e.g. silver or copper ion donor. In some embodiments, the catalyst is a cobalt, manganese, iron, molybdenum, or platinum, catalyst or a combination thereof. A chelating agent may be included to prevent the precipitation of the catalyst. However, maintaining the pH of the water at between about 6.8 and about 8.0, and more preferably between about 7.0 and about 7.8, will effectively limit precipitation.

Chelating agents form ligands that complex with a transition metal catalyst and improve its solubility in water, thereby allowing the catalyst to remain active as a catalyst. Any chelating agent that complexes with the transition metal catalyst will be effective in the methods and compositions of the invention.

Nitrogen bearing complexing (chelating) agents routinely employed by those of skill in the art include, but are not limited to: ethylenediaminetetraacetic acid (EDTA), diethylenetriaminepentaacetic acid (DTPA), nitrilotriacetic acid (NTA), and N(Hydroxyethyl) ethylenediaminetriacetic acid (HEDTA).

Common phosphonate based complexing (chelating) agents routinely employed by those of skill in the art include, but are not limited to: (1-hydroxyethylidene)diphosphonic acid (HEDP) and diethylenetriaminepenta (methylene phosphonic acid) (DTMPA).

Common organic acid (carboxylic acid) complexing (chelating) agents routinely employed by those of skill in the art include, but are not limited to: acetic acid, citric acid, lactic acid, succinic acid, oxalic acid, gluconic acid and the like.

The transition metal catalyst may make up between about 0.0001 wt. % and about 10 wt. % of the composition. In one exemplary embodiment, the transition metal catalyst constitutes between about 0.01 wt. % and about 10 wt. % of the composition while the persulfate donor constitutes between about 90 wt. % and about 99.99 wt. % of the composition.

The persulfate donor and the catalyst can also be combined with a free halogen donor. Free halogen donors act as an effective sanitizer/oxidizer and serve to rid the water of inorganic nitrogen such as mono- and di-chloroamines. In aspects of the invention where a free halogen donor is incorporated into the composition, the free halogen donor may make up between about 50-99 wt. % of the composition. In such cases, the persulfate donor and the catalyst would make up about 1-50 wt. % of the composition. The catalyst alone may make up about 0.00001 wt. % to 10 wt. % of the composition.

Exemplary free halogen donors include but are not limited to calcium hypochlorite, trichloroisocyanuric acid, dichloroisocyanuric acid, dibromodimethyl hydantoin, bromochlorodimethyl hydantoin, and lithium hypochlorite.

The compositions of the invention effectively deliver the persulfate donor to the water while maintaining the effective catalyst concentration in the water.

1 The composition may be provided in the form of a powder mixture, a granular mixture, or an agglomerate containing the persulfate donor and the catalyst.

1 To form a powder mixture, the catalyst is admixed with the persulfate donor in a container. To form the catalyst-coated granules, the persulfate donor may be prepared into granules and coated with the catalyst. The catalyst may be deposited on the surface of the granule uniformly or nonuniformly. In some embodiments, the coating may include a barrier film that isolates the persulfate donor from the surrounding environment (e.g., a free halogen donor). The persulfate-catalyst mixture or the catalyst-coated granules can be used as is, or agglomerated using pressure to form a tablet made of a plurality of granules.

The agglomerates may contain an agent that restricts the dissolution rate of the agglomerate. Examples of such agents include a substantially water insoluble wax, a mineral salt of a carboxylic acid having at least 16 carbons and a gel-forming material.

Examples of substantially water insoluble waxes include but are not limited to polyethylene wax, polyoxyethylene wax and their respective fatty acid ester wax. Examples of a mineral salt of a carboxylic acid having at least 16 carbons, include but are not limited to, calcium stearate and similar hydrocarbon based salts. Examples of a gel-forming material, include but are not limited to, polaxamers, polyacrylic acid, polyacrylamide, polyvinyl alcohol, polysaccharides such as xanthan, and various cellulose based derivatives. The gel-forming material forms a gelatinous structure upon exposure to water, effectively controlling the rate at which the agglomerate dissolves in the water.

The composition can also be combined with a sanitizer such as trichloroisocyanuric acid. Chemical oxygen demand generally impedes the sanitizer from performing its function. When the composition removes the chemical oxygen demand, the sanitizer is able to effectively improve the water quality without impediment.

The composition may be used periodically to prevent the COD level in water from getting too high, it may also be used to recover aquatic facilities that are already highly contaminated with organic based COD.

### EXAMPLE

1000 mL of a water-based stock solution containing 7.0 ppm persulfate was prepared by adding potassium persulfate (purchased from Sigma-Aldrich) to water and adjusting the pH to 7.2 using sodium bisulfate. The persulfate level was initially and periodically tested using ammonium thiocyanate and ferrous iron in an acidic solution. The stock solution was divided into 2-500 mL samples, and magnetic stirring rods were added to each sample. Using the magnetic stirrer, each sample was vigorously mixed to achieve a vortex reaching approximately half the distance to the stirring rod.

TABLE 1
Persulfate Decomposition Rate

| | Persulfate Conc. (ppm) | Persulfate Conc. (ppm) |
|---|---|---|
| Lapsed Time | with 0.63 ppm Ag | with 0.31 ppm Ag |
| (Hrs.) | catalyst | catalyst |
| 0 | 7.0 | 7.0 |
| 3 | 4.2 | 5.6 |
| 5 | 2.1 | 4.2 |
| 7 | <1.0 | 2.8 |

Table 1 shows that the persulfate concentration decreased with time. The test results in Table 1 illustrate that the catalyst, under conditions like those experienced in pools, can effectively decompose the persulfate irritant.

As the reactions proceed and the hydroxyl radicals are reduced, the pH of the solution increases. Therefore, during the test period, the pH was measured every 30 minutes and a solution of sodium bisulfate was administered as needed to maintain the pH at a range of about 7.2 to 7.5.

The test result indicates that when the reaction occurs in COD-laden water, the sulfate free radicals will enhance the effectiveness of the treatment (e.g., PMPS treatment) for decomposing the COD. Moreover, with the persulfate irritant being removed rapidly with the catalyst, the invention allows PMPS (which is usually accompanied by some persulfate) to be applied while swimmers and bathers are present in the water.

The composition, which is substantially soluble in water, may be made into a solution before being added to the COD-laden water. In some cases, the solution is preparted in a container before being delivered to the pool by an eductor system, a chemical metering pump, or pressure differential between the inlet and outlet water supply of the container. In other cases, the solution is made by adding the composition (e.g., in agglomerated form) to the circulating water of the system.

If desired, additional persulfate donor can be fed separately to the water to further enhance the formation of sulfate free radicals.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention.

What is claimed is:

1. A composition for reducing chemical oxygen demand in water, comprising: a sulfate free radical precursor and a transition metal catalyst in contact with said sulfate free radical precursor, wherein the transition metal catalyst makes up between about 0.0001 wt. % and about 10 wt. % of the composition.

2. The composition of claim 1, wherein the transition metal catalyst coats the sulfate free radical precursor.

3. The composition of claim 1, wherein the composition is dissolved in water to form a solution that is delivered to the water.

4. The composition of claim 1, wherein the composition is powder.

5. The composition of claim 1, wherein the composition is granular.

6. The composition of claim 1, wherein the composition is an agglomerate.

7. The composition of claim 6, further comprising an agent that restricts a dissolution rate of the agglomerate in water.

8. The composition of claim 7, wherein the agent is a substantially water-insoluble wax.

9. The composition of claim 7, wherein the agent is a mineral salt of a carboxylic acid having at least 16 carbons.

10. The composition of claim 7, wherein the agent is a gel forming material that forms a gelatinous structure upon contacting water.

11. The composition of claim 1, wherein the sulfate free radical precursor is one or more of potassium monopersulfate, sodium persulfate, and potassium persulfate.

12. The composition of claim 11, wherein sulfate free radical precursor is potassium monopersulfate

13. The composition of claim 1, wherein the transition metal catalyst comprises cobalt.

14. The composition of claim 13, wherein said cobalt is an inorganic salt.

15. The composition of claim 13 wherein said cobalt is a bound by an organic based ligand bearing compound.

16. The composition of claim 13 wherein said cobalt is an oxide.

17. The composition of claim 1, wherein the transition metal catalyst comprises manganese.

18. The composition of claim 17, wherein said manganese is an inorganic salt.

19. The composition of claim 17, wherein said manganese is a bound by an organic based ligand bearing compound.

20. The composition of claim 17, wherein said manganese is an oxide.

21. The composition of claim 1, further comprising a chelating agent in contact with the transition metal catalyst.

22. The composition of claim 1, further comprising a coagulating agent.

23. A composition according to claim 1, for use in an aquatic facility.

24. A composition for reducing chemical oxygen demand in water, comprising:
a free halogen donor;
a sulfate free radical precursor; and
a transition metal catalyst, wherein the free halogen donor, the sulfate free radical precursor, and the transition metal catalyst are agglomerated.

25. The composition of claim 24, wherein the composition is soluble in water.

26. The composition of claim 24, wherein the sulfate free radical precursor is one or more of potassium monopersulfate, sodium persulfate and potassium persulfate.

27. The composition of claim 24, wherein the sulfate free radical donor is potassium monopersulfate.

28. The composition of claim 24, wherein the transition metal catalyst is present in an amount between about 0.00001 wt. % and 10 wt. % of the composition.

29. The composition of claim 24, wherein the transition metal catalyst comprises cobalt.

30. The composition of claim 29, wherein said cobalt is a salt.

31. The composition of claim 29, wherein said cobalt is a bound by an organic based ligand bearing compound.

32. The composition of claim 24, wherein the transition metal catalyst comprises manganese.

33. The composition of claim 32, wherein said manganese is an oxide.

34. The composition of claim 32, wherein said manganese is a salt.

35. The composition of claim 32, wherein said manganese is a bound by an organic based ligand bearing compound.

36. The composition of claim 32, wherein said manganese is an oxide.

37. The composition of claim 24, further comprising a chelating agent in contact with the transition metal catalyst.

38. The composition of claim 24, wherein the free halogen donor is one or more of calcium hypochlorite, trichloroisocyanuric acid, dichloroisocyanuric acid, dibromodimethyl hydantoin, bromochlorodimethyl hydantoin and lithium hypochlorite.

39. The composition of claim 24, wherein the sulfate free radical precursor is separated from the free halogen donor.

40. The composition of claim 24 further comprising a chlorite donor.

41. The composition of claim 24, further comprising a coagulating agent.

42. The composition of claim 24, wherein the free halogen donor comprises about 50-99 wt. % of the composition.

43. The composition of claim 24, wherein the sulfate free radical precursor and the transition metal catalyst comprise about 1-50 wt. % of the composition.

44. The composition of claim 24, further comprising an agent that restricts a dissolution rate of the composition.

45. The composition of claim 44, wherein the agent is a substantially water-insoluble wax.

46. The composition of claim 44, wherein the agent is a mineral salt of a carboxylic acid having at least 16 carbons.

47. The composition of claim 44, wherein the agent is a gel forming material that forms a gelatinous structure upon contacting water.

48. The composition of claim 24, for use in an aquatic facility.

49. A method of removing chemical oxygen demand from water, the method comprising:
maintaining a transition metal catalyst concentration level of between about 1 ppb and about 1 ppm measured as elemental metal in the water and adding a sulfate free radical precursor to the water.

50. The method of claim 49, wherein the catalyst comprises cobalt.

51. The composition of claim 50, wherein said cobalt is a salt.

52. The method of claim 50, wherein said cobalt is a bound by an organic based ligand bearing compound.

53. The method of claim 50, wherein said cobalt is an oxide.

54. The method of claim 49, wherein the catalyst comprises manganese.

55. The method of claim 54, wherein said manganese is an oxide.

56. The method of claim 54, wherein said manganese is a salt.

57. The method of claim 54, wherein said manganese is a bound by an organic based ligand bearing compound.

58. The method of claim 54, wherein said manganese is an oxide.

59. The method of claim 49, further comprising adding a chelating agent to the water.

60. The method of claim 49, wherein the sulfate free radical precursor is one or more of potassium monopersulfate, sodium persulfate and potassium persulfate.

61. The method of claim 49, wherein the sulfate free radical precursor is potassium monopersulfate.

62. The method of claim 49, wherein the sulfate free radical precursor is added in the form of a solution.

63. The method of claim 49, further comprising forming the solution by admixing said sulfate free radical precursor powder with water in a container.

64. The method of claim 49, further comprising forming the solution by passing the water over an agglomerate of said sulfate free radical precursor.

65. The method of claim 49, further comprising:
agglomerating the sulfate free radical precursor with an agent to form an agglomerate, wherein said agent restricts the dissolution rate of the agglomerate in the water.

66. The method of claim 65, wherein the agent is a substantially water-insoluble wax.

67. The method of claim 65, wherein the agent is a mineral salt of a carboxylic acid having at least 16 carbons.

68. The method of claim 65, wherein the agent is a gel forming material that forms a gelatinous structure upon contacting water.

69. The method of claim 49, wherein said maintaining the transition metal catalyst concentration level and said adding of the sulfate free radical precursor is accomplished while mammals are present in the water.

70. A method of removing chemical oxygen demand from water containing organic contaminants, said method comprising:
preparing a sulfate free radical precursor solution;
adding a catalyst to the sulfate free radical precursor solution; and
feeding the sulfate free radical precursor solution to the water.

71. The method of claim 70, wherein the catalyst comprises cobalt.

72. The method of claim 71, wherein said cobalt is a salt.

73. The method of claim 71, wherein said cobalt is a bound by an organic based ligand bearing compound.

74. The method of claim 71, wherein said cobalt is an oxide.

75. The method of claim 70, wherein the catalyst comprises manganese.

76. The method of claim 75, wherein said manganese is an oxide.

77. The method of claim 75, wherein said manganese is a salt.

78. The method of claim 75, wherein said manganese is a bound by an organic based ligand bearing compound.

79. The method of claim 75, wherein said manganese is an oxide.

80. The method of claim 70, further comprising adding a chelating agent to the composition.

81. The method of claim 70, wherein the sulfate free radical precursor is one or more of potassium monopersulfate, sodium persulfate, and potassium persulfate.

82. The method of claim 81, wherein the sulfate free radical precursor is potassium monopersulfate.

83. The method of claim 70, wherein preparing the sulfate free radical precursor solution comprises admixing sulfate free radical precursor powder with water in a container.

84. The method of claim 70, further comprising feeding the sulfate free radical precursor solution to the water to obtain about 1 ppb to about 1 ppm of the catalyst measured as elemental metal in the water.

85. The method of claim 84, wherein the water comprises from about 5 ppb and about 500 ppb of the catalyst.

86. The method of claim 70, wherein said adding and said feeding are accomplished while mammals are present in the water.

87. A composition for removing chemical oxygen demand from an aquatic facility, the composition comprising:
a transition metal catalyst in an amount that makes up between about 0.01 wt. % and about 10 wt. % of the composition; and
a sulfate free radical precursor in an amount that makes up between about 90-99.99 wt. % of the composition.

88. A method of removing chemical oxygen demand from an aqueous system, the method comprising:
adding a sulfate free radical precursor to the aqueous system; and
adding a catalyst comprising cobalt donor to the water to achieve from about 1 ppb to 1 ppm of catalyst measured as elemental cobalt.

89. The method of claim 88, wherein said sulfate free radical precursor and said catalyst are added separately.

90. The method of claim 88, wherein said sulfate free radical precursor and said catalyst are added together.

91. The method of claim 88, wherein said sulfate free radical precursor and said catalyst are added are admixed prior to addition to the aqueous system.

92. The method of claim 88, wherein said aqueous system is an aquatic system.

93. The method of claim 88, further comprising adding a free halogen donor to the aqueous system.

94. A composition for reducing chemical oxygen demand in an aquatic system containing organic contaminants, comprising:
a free halogen donor;
a sulfate free radical precursor; and
a transition metal catalyst comprising a cobalt donor, wherein the composition is applied to the system to provide a composition dosage of from 5 ppm to 1000 ppm, and a catalyst concentration determined as elemental cobalt from 1 ppb to 1 ppm.

95. The composition of claim 94, further comprising a ligand bearing complexing agent.

96. The composition of claim 94, further comprising a pH buffering agent.

97. The composition of claim 94, further comprising a coagulating agent

98. The composition of claim 94, wherein the sulfate free radical precursor is one or more of potassium monopersulfate, sodium persulfate, and potassium persulfate.

99. The composition of claim 94, wherein said sulfate free radical precursor is potassium monopersulfate.

100. The composition of claim 94, wherein said free halogen donor is one or more of calcium hypochlorite, trichloroisocyanuric acid, dichloroisocyanuric acid, dibromodimethyl hydantoin, bromochlorodimethyl hydantoin and lithium hypochlorite.
